(19) United States
(12) Patent Application Publication
(10) Pub. No.: US 2025/0091154 A1
(43) Pub. Date: Mar. 20, 2025

(54) CHIP COLLECTION SYSTEM

(71) Applicant: KYOKUTOH CO., LTD., Aichi (JP)

(72) Inventor: Hirokazu KUSANO, Aichi (JP)

(21) Appl. No.: 18/964,062

(22) Filed: Nov. 29, 2024

Related U.S. Application Data
(63) Continuation of application No. PCT/JP2023/019159, filed on May 23, 2023.

(30) Foreign Application Priority Data
Jun. 29, 2022 (JP) 2022-104346

(51) Int. Cl. B23K 9/26; B23K 9/007

(52) U.S. Cl. CPC B23K 9/26; B23K 9/007

(57) ABSTRACT

A chip collection system includes a tip dresser that cuts a distal end of an electrode tip for spot welding, and a suction unit that sucks and collects chips (M1) produced when the distal end of the electrode tip is cut with the tip dresser. The suction unit includes an electric motor (6) being rotatable, a centrifugal impeller (5) rotatable by the electric motor (6) to generate a suction force, and a chip collection case (9) into which the chips (M1) are collectable. The suction unit collects chips (M1) moving with air sucked in response to rotation of the centrifugal impeller (5) into the chip collection case (9).

### CROSS-REFERENCE TO RELATED APPLICATIONS

This application is a continuation application of International Patent Application No. PCT/JP2023/019159 filed on May 23, 2023, which claims priority to Japanese Patent Application No. 2022-104346 filed on Jun. 29, 2022, the entire contents of which are incorporated by reference.

### BACKGROUND OF INVENTION

### Field of the Invention

The present invention relates to a chip collection system that collects chips produced when the distal end of an electrode tip for spot welding is cut with a tip dresser.

### Background Art

A known welding gun used for spot welding includes a shank having a distal end to which a copper electrode tip is attached in a detachable manner. The electrode tip includes a distal end portion that wears or deteriorates with, for example, an oxide film adhering to the distal end portion after welding performed a predetermined number of times. The electrode tip is thus periodically cut using a tip dresser to remove, for example, the oxide film.

Chips produced when the distal end of the electrode tip is cut with the tip dresser may accumulate on a drive in the device, and may thus increase a load on the drive, possibly causing a failure of the device. Chips are thus to be collected immediately after being produced.

In response to this, for example, the chip collection system described in Patent Literature 1 includes a suction unit that can suck chips. The suction unit includes a duct having one end with a chip suction port and the other end connected to a chip collection case. The duct has, in its intermediate portion, an air inlet port that allows compressed air to be introduced into the duct. Compressed air is introduced through the air inlet port to a space closer to the chip collection case inside the duct to create a negative pressure in a space closer to the chip suction port inside the duct. This generates airflow flowing toward the chip collection case in the duct. Chips falling from a tip dresser are thus sucked into the duct through the chip suction port with air and collected in the chip collection case.

### CITATION LIST

### Patent Literature

Patent Literature 1: Korean Registered Patent No. 10-1696263

### SUMMARY OF INVENTION

### Technical Problem

Nowadays, to improve the work environment at a factory by greatly reducing noise and achieving a quiet and comfortable workplace, the use of a compressor may be avoided, whereas a compressor is otherwise typically installed at a factory to supply compressed air. For the suction unit used for a tip dresser described in Patent Literature 1 as well, the technique for collecting chips quietly without compressed air from a compressor installed at a factory is awaited.

In response to the above, one or more aspects of the present invention are directed to a chip collection system that reduces noise generated when in use without reducing its chip collection performance, thus improving the work environment.

### Solution to Problem

In response to the above, the chip collection system according to one or more aspects of the present invention uses a drive source specifically designed to activate a component that generates a suction force.

More specifically, the chip collection system according to one or more aspects of the present invention includes a tip dresser that cuts a distal end of an electrode tip for spot welding, and a suction unit that sucks and collects chips produced when the distal end of the electrode tip is cut with the tip dresser. The chip collection system has the structure described below.

In a chip collection system according to a first aspect, the suction unit includes an electric motor being rotatable, an impeller rotatable by the electric motor to generate a suction force, and a chip collection case into which the chips are collectable. The suction unit collects chips moving with air sucked in response to rotation of the impeller into the chip collection case.

A chip collection system according to a second aspect is the chip collection system according to the first aspect further including a cover including an upper wall being disk-shaped and having a centerline extending vertically and a side wall being cylindrical and extending downward from an outer circumferential edge of the upper wall. The cover is open downward. The cover covers the electric motor and the impeller.

A chip collection system according to a third aspect is the chip collection system according to the second aspect in which the impeller is a centrifugal impeller with a rotation center extending in a vertical direction and including a suction port facing downward. The electric motor is located above the impeller.

A chip collection system according to a fourth aspect is the chip collection system according to the third aspect in which the cover has a chip inlet port through which air including the chips is introduced into an inner space of the cover from outside. The cover contains, in the inner space, a partition dividing the inner space into an upper area accommodating the electric motor and the impeller and a lower area corresponding to the chip inlet port. The partition has a connection hole corresponding to the suction port at a center of the partition. An air filter is located below the partition. The air filter is a vertically elongated bottomed cylinder having an air outlet connecting with the connection hole. The air filter has, in an outer circumferential surface of the air filter, a plurality of air inlets through which air flows into an inner space of the air filter from outside. The chip collection case is a bottomed cylinder having an attachment opening portion being open upward and attachable to the cover to close a lower end opening of the cover.

A chip collection system according to a fifth aspect is the chip collection system according to the fourth aspect in which the air filter contains a porous member in the inner space.

A chip collection system according to a sixth aspect is the chip collection system according to the fourth aspect or the fifth aspect further including an attachment bracket with which the suction unit is attachable to an attachment body. The cover includes a fitting wall having an outer circumferential surface having a regular polygonal shape about a centerline of the cover when viewed in a direction along the centerline. The attachment bracket has a fitting hole to receive the fitting wall. The fitting hole has a same regular polygonal shape as the fitting wall.

A chip collection system according to a seventh aspect is the chip collection system according to any one of the third to fifth aspects in which the cover has, in a portion of an outer circumferential surface of the cover corresponding to the centrifugal impeller, a plurality of outlets through which air expelled radially outward from the centrifugal impeller is discharged out of the cover. The plurality of outlets are arranged along a circumference of the cover.

A chip collection system according to an eighth aspect is the chip collection system according to the seventh aspect in which the cover has, in an area of the outer circumferential surface of the cover excluding the plurality of outlets, a plurality of recessed grooves arranged adjacent to one another and extending in a same direction and a plurality of ridges arranged adjacent to one another and extending in a same direction. Each of the plurality of ridges is located between adjacent recessed grooves of the plurality of recessed grooves.

A chip collection system according to a ninth aspect is the chip collection system according to the eighth aspect in which the cover includes a pair of split portions formed from a resin. The pair of split portions are portions of the cover halved at the centerline and having a same shape. The cover is an assembly of the pair of split portions including opening end edges abutting against each other. The plurality of recessed grooves are recessed in a direction in which the pair of split portions are arranged. The plurality of ridges protrude in the direction in which the pair of split portions are arranged. The plurality of outlets extend through the cover in the direction in which the pair of split portions are arranged.

A chip collection system according to a tenth aspect is the chip collection system according to the first aspect in which the chip collection case is a single member formed from a transparent resin material.

A chip collection system according to an eleventh aspect is the chip collection system according to the fourth aspect or the fifth aspect in which the chip collection case has, on an outer circumferential surface of the chip collection case, a plurality of annular grooves arranged in a direction parallel to a cylinder centerline. Each of the plurality of annular grooves is recessed in an arc in a cross section taken along the cylinder centerline and extends along a circumference of the chip collection case about the cylinder centerline.

### Advantageous Effects

In the first aspect, the impeller that generates a suction force to collect chips is rotated by a driving force of the electric motor. Thus, a compressor typically installed at a factory as described in Patent Literature 1 is not to be activated in collecting chips. Thus, the chip collection system greatly reduces noise generated when in use without reducing its chip collection performance, thus improving the work environment.

In the second aspect, for example, when cooling water for cooling the electrode tip leaks from, for example, a welding gun and falls from above the suction unit, the structure prevents the cooling water from directly accumulating on the electric motor and the impeller.

In the third aspect, the centrifugal impeller is located below the electric motor. Thus, the electric motor is less likely to be reached by, for example, the cooling water from below. The chip collection system is thus highly waterproof.

In the fourth aspect, in response to the centrifugal impeller being rotated to generate a suction force as the electric motor is driven to rotate, air is introduced into the chip collection case through the chip inlet port. Then, through the air inlets and the air outlet, the air passes through the air filter while moving upward, and reaches the centrifugal impeller through the connection hole. The chips are introduced through the chip inlet port together with the air in this airflow. When the chips are to pass through the air filter, the chips are blocked by the air filter and remain in the chip collection case. An operator can easily discard the chips remaining in the chip collection case after detaching the chip collection case from the cover. In this manner, the chips can be collected and discarded efficiently.

In the fifth aspect, the porous member in the inner space of the air filter absorbs sound generated when air passes through the air filter. This further reduces noise generated when the chip collection system is in use.

In the sixth aspect, the fitting wall can be fitted into the fitting hole with the cover rotated about the centerline of the cover by a predetermined angle relative to the attachment bracket. The position of the chip inlet port with respect to the attachment body can thus be changed based on the surroundings of the suction unit.

In the seventh aspect, areas through which the discharged air expelled radially outward from the centrifugal impeller passes through the cover are increased, and are arranged in a distributed manner in the circumferential direction of the cover. This structure reduces the momentum of the discharged air passing through the cover, causing sound produced when the discharged air passes through the cover to be less noisy. This further reduces noise generated when the chip collection system is in use.

In the eighth aspect, the cover is lighter by the weight of the volume corresponding to the spaces defining the recessed grooves, and has a greater section modulus at the area for each ridge and is thus more rigid. The chip collection system is thus highly rigid and light.

In the ninth aspect, the split portions can each be formed from a resin material as a single member using a mold with its opening direction set to the direction in which the split portions are arranged. This avoids undercuts and allows molding of the split portions each with a complex profile having the multiple recessed grooves, the multiple ridges, and the multiple outlets with a single mold. Fewer molds are thus used in molding, reducing the cost for manufacturing the suction unit.

In the tenth aspect, the operator can visually check the inside of the chip collection case from outside. The operator can thus check the collected amount of the chips to discard them. This increases the work efficiency.

In the eleventh aspect, the chip collection case has a greater section modulus at a cross section taken along the cylinder centerline and is thus more rigid with a force in a direction toward the cylinder centerline. Thus, when a large suction force is generated in a direction toward the air filter aligned with the cylinder centerline of the chip collection case during the operation of the chip collection system, the chip collection case is prevented from deforming and reducing an area to collect chips.

### BRIEF DESCRIPTION OF THE DRAWINGS

FIG. 1 is a schematic perspective view of a chip collection system according to an embodiment of the present invention.

FIG. 2 is a perspective view of a unit body of a suction unit in the embodiment of the present invention.

FIG. 3 is an exploded perspective view of the upper half of the unit body of the suction unit in the embodiment of the present invention.

FIG. 4 is an exploded perspective view of the lower half of the unit body of the suction unit in the embodiment of the present invention.

FIG. 5 is a sectional view taken along line V-V in FIG. 2.

FIG. 6 is a sectional view taken along line VI-VI in FIG. 5.

### DETAILED DESCRIPTION

An embodiment of the present invention will now be described in detail with reference to the drawings. The embodiment described below is a mere example.

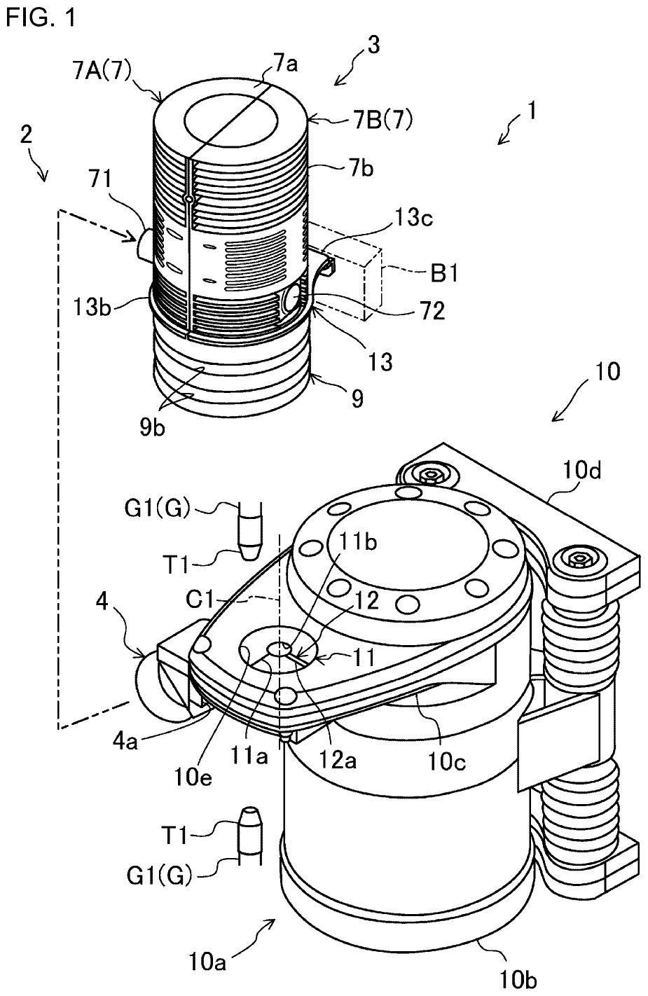

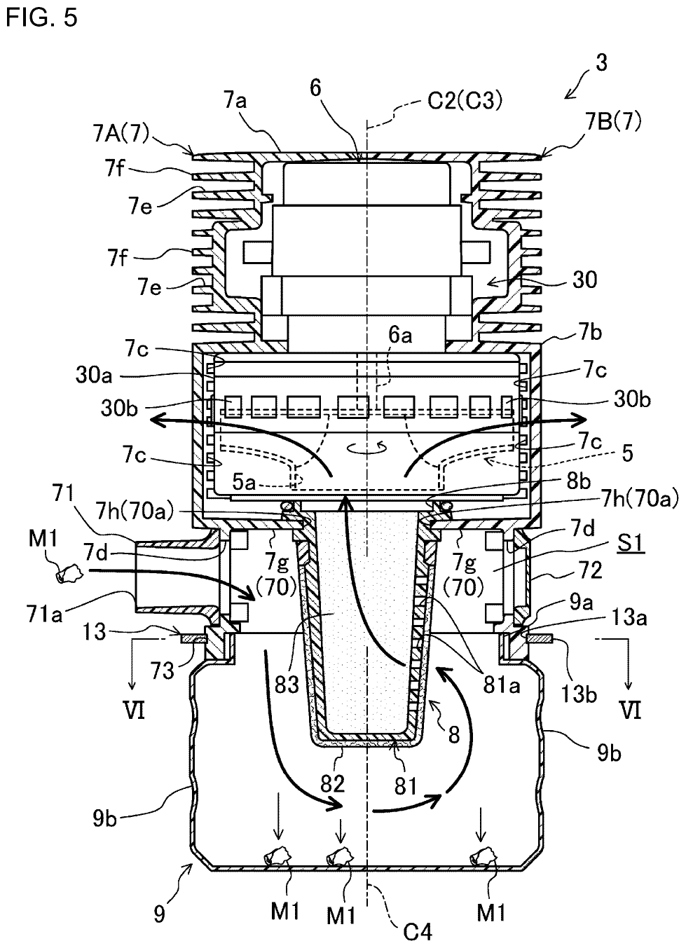

FIG. 1 shows a chip collection system 1 according to the embodiment of the present invention. The chip collection system 1 includes a tip dresser 10 and a suction unit 2. The tip dresser 10 can cut the distal ends of a pair of electrode tips T1 attached to a welding gun G for spot welding. The suction unit 2 sucks and collects chips M1 (refer to FIG. 5) produced when the distal ends of the electrode tips T1 are cut with the tip dresser 10.

The tip dresser 10 includes a body case 10a that is substantially L-shaped when viewed laterally. The body case 10a includes a motor compartment 10b that is a bottomed cylinder with its centerline extending vertically and a holder compartment 10c extending laterally from an upper portion of the motor compartment 10b in a substantially horizontal direction. The holder compartment 10c has substantially a droplet shape when viewed from above.

A shock absorber 10d that absorbs shock on the body case 10a is attached to the side surface of the motor compartment 10b adjacent to a basal end of the holder compartment 10c.

The holder compartment 10c is a plate with a thickness. The holder compartment 10c has a holder support hole 10e in the middle of its extending portion. The holder support hole 10e is open vertically.

The holder support hole 10e in the holder compartment 10c receives a rotary holder 11 with a rotation axis C1 extending in the vertical direction. The rotary holder 11 is rotated about the rotation axis C1 by a drive motor (not shown) accommodated in the motor compartment 10b.

The rotary holder 11 is substantially C-shaped when viewed from above. The rotary holder 11 has a cutout 11a that is wider in the circumferential direction about the rotation axis C1 at radially more outward positions from the rotation axis C1. The cutout 11a is open outward and vertically.

The rotary holder 11 has, on its upper and lower surfaces, a pair of curved recesses 11b having a diameter gradually decreasing toward the center of the rotary holder 11. The curved recesses 11b are symmetrical to each other in the direction of the rotation axis C1. FIG. 1 shows an upper curved recess 11b of the pair of curved recesses 11b alone.

The curved recesses 11b have a shape corresponding to the curved shape of the distal ends of the electrode tips T1. With the central axis of the electrode tips T1 aligned with the rotation axis C1, the curved recesses 11b can receive the distal ends of the electrode tips T1.

The cutout 11a has one inner surface extending outward from the rotation axis C1 to which a cutter 12 for cutting the distal ends of the electrode tips T1 is attached.

The cutter 12 includes a cutting blade 12a extending in a direction intersecting with the rotation axis C1. The cutting blade 12a gradually curves to correspond to the curved recesses 11b.

With the rotary holder 11 being rotated, one of the pair of electrode tips T1 facing each other is inserted into the upper curved recess 11b, and the other electrode tip is inserted into a lower curved recess (not shown). This causes the cutting blade 12a on the cutter 12 to cut the distal end of each electrode tip T1.

The suction unit 2 includes a unit body 3 that is substantially a column with its centerline extending in the vertical direction and a duct hose 4 that guides the chips M1 produced in the tip dresser 10 to the unit body 3.

The duct hose 4 has one end with a chip suction port 4a and the other end connected to the unit body 3. The chip suction port 4a faces a chip receiving area below the rotary holder 11 in the tip dresser 10.

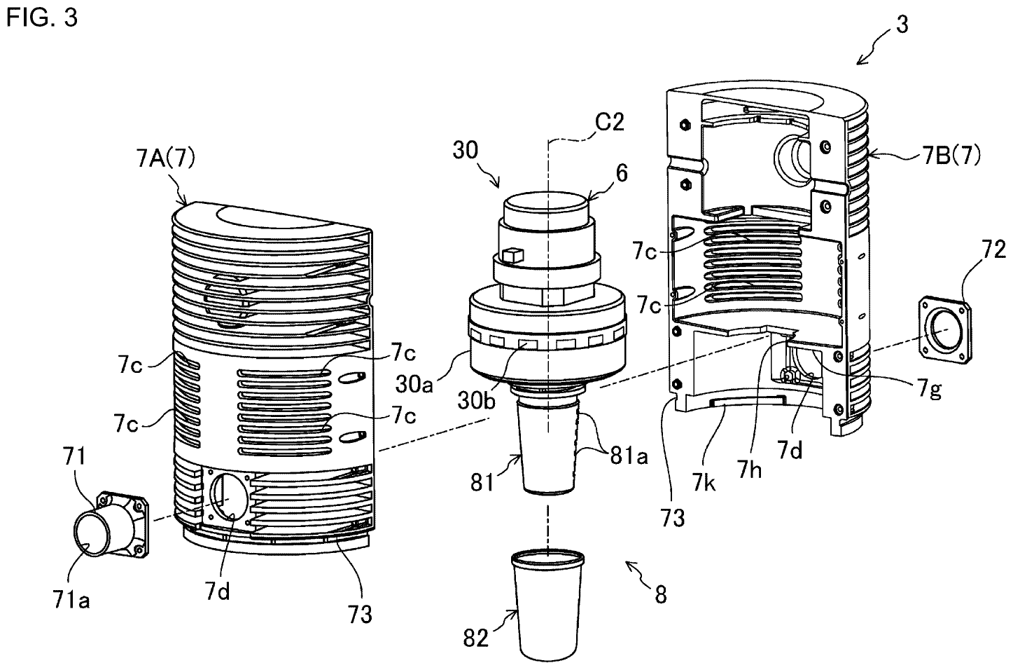

As shown in FIG. 3, the unit body 3 includes a blower unit 30 that is substantially T-shaped when viewed laterally and a resin cover 7 covering the blower unit 30.

As shown in FIG. 5, the blower unit 30 includes a substantially disk-shaped centrifugal impeller 5 with a rotation center C2 extending in the vertical direction and including a suction port 5a facing downward, and an electric motor 6 located above the centrifugal impeller 5 and including a rotational shaft 6a extending downward.

The centrifugal impeller 5 is accommodated in a disk-shaped blower cover 30a with a thickness. The blower cover 30a is open downward and has multiple air vents 30b in its outer circumferential surface.

The centrifugal impeller 5 rotates about the rotation center C2 in response to the electric motor 6 rotating, causing air sucked upward through the suction port 5a to move radially outward and be discharged out of the blower cover 30a through the air vents 30b. The centrifugal impeller 5 thus generates a suction force.

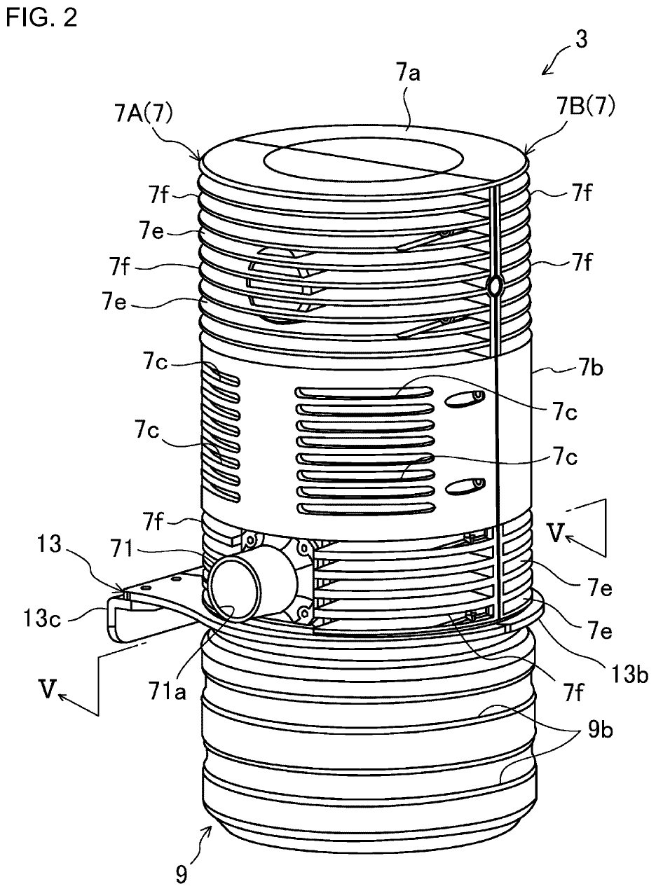

As shown in FIG. 2, the cover 7 includes a disk-shaped upper wall 7a with a centerline C3 extending vertically and a cylindrical side wall 7b extending downward from the outer circumferential edge of the upper wall 7a. The cover 7 is open downward.

As shown in FIG. 3, the cover 7 includes, on the circumferential edge of the opening, multiple upper bayonet tabs 7k arranged at predetermined intervals about the centerline C3. FIG. 3 shows one upper bayonet tab 7k alone.

As shown in FIG. 2, the cover 7 includes a first split portion 7A and a second split portion 7B each having a shape obtained by halving the cover 7 at the centerline C3.

The first split portion 7A has, in its intermediate area, multiple outlets 7c arranged along the centerline C3. The outlets 7c are slits extending through the first split portion 7A in a direction in which the first split portion 7A and the second split portion 7B are arranged and elongated circumferentially about the centerline C3.

The first split portion 7A includes an opening portion 7d in the middle of its lower area as shown in FIG. 3.

The first split portion 7A has, in areas of its outer surface excluding the outlets 7c, multiple recessed grooves 7e arranged adjacent to one another. The recessed grooves 7e are recessed in the direction in which the first split portion 7A and the second split portion 7B are arranged and extend in the same direction. The recessed grooves 7e extend in a direction intersecting with the centerline C3 and along a plane by which the cover 7 is split.

The first split portion 7A has, between the recessed grooves 7e on its outer surface, multiple ridges 7f protruding in the direction in which the first split portion 7A and the second split portion 7B are arranged and extending in the same direction as the recessed grooves 7e.

As shown in FIG. 5, the first split portion 7A includes, on a portion of its inner surface close to the bottom, a protruding plate 7g protruding toward the second split portion 7B. The protruding plate 7g divides the inner space of the first split portion 7A into an upper area and a lower area. The protruding plate 7g has a cutout recess 7h that is open at a protruding end of the protruding plate 7g.

The second split portion 7B has the same structure as the first split portion 7A described above. The same reference numerals denote the same components as those of the first split portion 7A. Such components will not be described in detail.

The first split portion 7A and the second split portion 7B are each a single member formed from a resin material using a single mold with its opening direction set to the direction in which the first split portion 7A and the second split portion 7B are arranged.

As shown in FIG. 3, the cover 7 is assembled by abutting the edges of the opening ends of the first split portion 7A and the second split portion 7B, with the blower unit 30 placed between the first split portion 7A and the second split portion 7B. In the assembled cover 7, as shown in FIG. 5, the protruding plate 7g in the first split portion 7A and the protruding plate 7g in the second split portion 7B define a partition 70 that divides an internal space S1 of the cover 7 into an upper area accommodating the blower unit 30 and a lower area corresponding to the opening portion 7d, and the cutout recess 7h in the first split portion 7A and the cutout recess 7h in the second split portion 7B define a connection hole 70a corresponding to the suction port 5a in the centrifugal impeller 5.

In the assembled cover 7, the outlets 7c are in a portion of the outer circumferential surface of the cover 7 corresponding to the centrifugal impeller 5. In other words, the outlets 7c are arranged along the circumference of the cover 7 and allow air expelled radially outward from the centrifugal impeller 5 to be discharged out of the cover 7.

A cylindrical member 71 is fitted to the opening portion 7d in the first split portion 7A of the cover 7. The cylindrical member 71 has an inner space that is a chip inlet port 71a through which air including the chips M1 is introduced into the inner space of the cover 7 from outside the cover 7.

In contrast, the opening portion 7d in the second split portion 7B of the cover 7 has an end adjacent to the outer circumferential surface of the cover 7 closed by a lid 72 that is a rectangular plate.

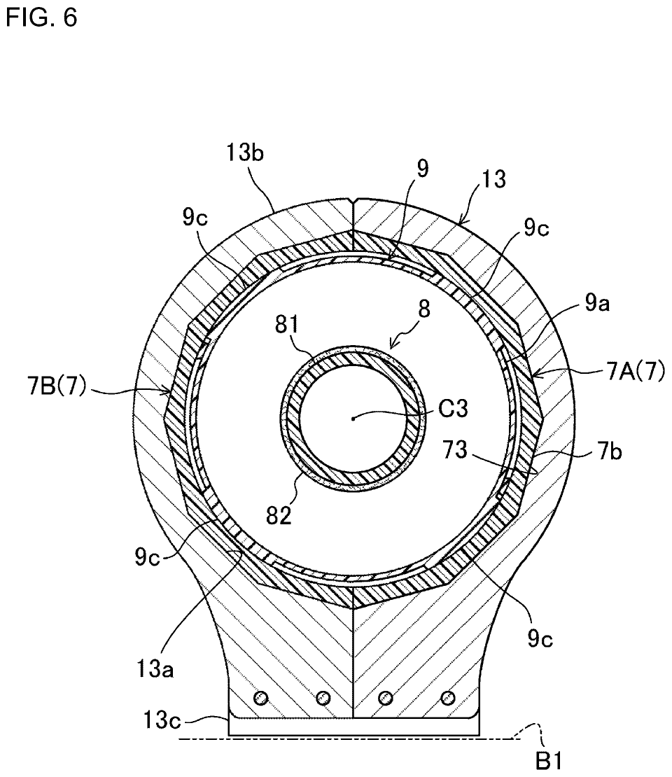

The cover 7 includes a fitting wall 73 on a portion of its outer circumferential surface that is close to its lower end and adjacent to the upper bayonet tabs 7k. The fitting wall 73 is located inward toward the centerline C3 and is continuous about the centerline C3. As shown in FIG. 6, the fitting wall 73 has an outer circumferential surface having a regular dodecagonal shape about the centerline C3 when viewed in a direction along the centerline C3.

An air filter 8 is located below the partition 70 as shown in FIG. 5. The air filter 8 is a vertically elongated bottomed cylinder and has an air outlet 8b connecting with the connection hole 70a.

The air filter 8 is tapered to have the diameter of its outer circumferential surface gradually decreasing downward. The air filter 8 includes a filter body 81 that is a single member formed from a resin material and a filter 82 of nonwoven fabric covering the filter body 81 from above.

The filter body 81 has, in a portion of its outer circumferential surface that is farther from the cylindrical member 71, multiple air inlets 81a that are slits elongated circumferentially about the centerline C3. The air inlets 81a are arranged vertically. Air flows into the inner space of the air filter 8 from outside the air filter 8 through the air inlets 81a.

The filter body 81 has an inner space filled with a porous member 83. The porous member 83 may be a member with many pores and high sound absorbency such as sponge or resin foam.

As shown in FIG. 1, the cover 7 has its lower portion supported by an attachment bracket 13 for attaching the suction unit 2 to an attachment body B1, such as a support frame.

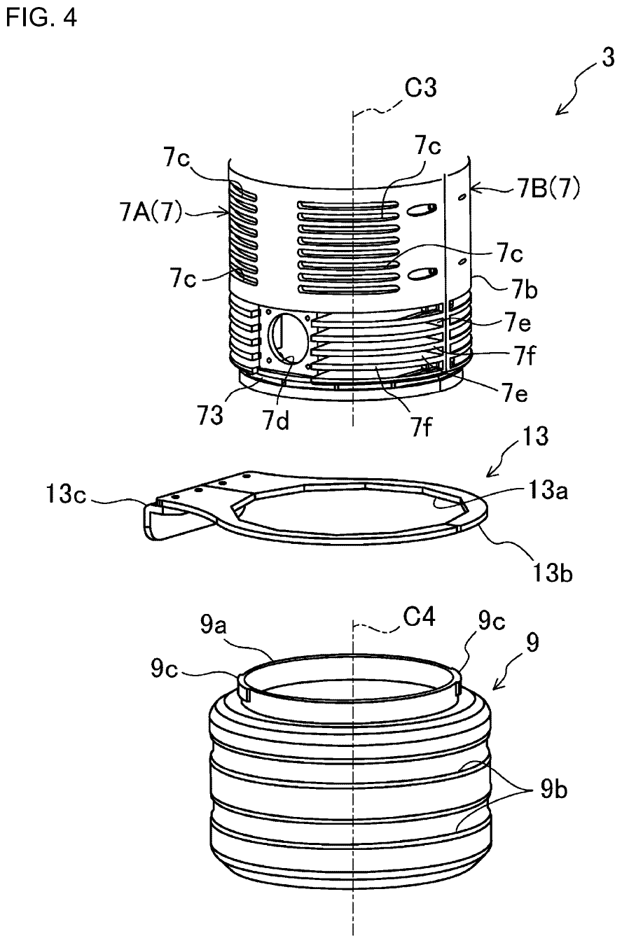

The attachment bracket 13 includes a bracket body 13b and an attachment portion 13c as shown in FIG. 4. The bracket body 13b has an internal fitting hole 13a and is annular when viewed from above. The attachment portion 13c continuously extends outward from a portion of the outer circumferential edge of the bracket body 13b and has a substantially L-shaped longitudinal cross section. The fitting hole 13a receives the fitting wall 73 and has the same regular dodecagonal shape as the fitting wall 73.

The attachment bracket 13 can be halved at the middle of the attachment portion 13c. The attachment bracket 13 is assembled by laterally holding the fitting wall 73 of the cover 7 with the resultant halves. This causes the fitting wall 73 to be fitted to the fitting hole 13a.

A chip collection case 9 is located below the cover 7. The chip collection case 9 is a bottomed cylinder including an attachment opening portion 9a that is open upward. The chip collection case 9 is a single member formed from a transparent resin material.

The chip collection case 9 has, on its outer circumferential surface, multiple annular grooves 9b arranged in a direction parallel to a cylinder centerline C4. As shown in FIG. 5, the annular grooves 9b are recessed toward the cylinder centerline C4 in an arc in a cross section taken along the cylinder centerline C4 and extend along the circumference of the chip collection case 9 about the cylinder centerline C4.

As shown in FIG. 4, a pair of lower bayonet tabs 9c are arranged along the attachment opening portion 9a of the chip collection case 9 at predetermined intervals about the cylinder centerline C4.

The lower bayonet tabs 9c are engaged with the upper bayonet tabs 7k in the cover 7. This allows the chip collection case 9 to be attached to the cover 7 with the opening in the lower end of the cover 7 being closed.

The operation of the suction unit 2 for collecting chips will now be described.

When the tip dresser 10 starts cutting the electrode tips T1 attached to shanks G1 included in the welding gun G for spot welding, the suction unit 2 is turned on, and the electric motor 6 rotates as shown in FIG. 5.

In response to the rotational shaft 6a rotating as the electric motor 6 rotates, the centrifugal impeller 5 rotates. In the centrifugal impeller 5, air sucked upward through the suction port 5a changes its direction and moves outward in the radial direction of the centrifugal impeller 5, passes through the air vents 30b in the blower cover 30a, and is then discharged through the outlets 7c in the cover 7. Through this series of movement, a suction force is generated in the suction unit 2.

In response to a suction force being generated in the suction unit 2, air is sucked through the chip suction port 4a of the duct hose 4 and introduced into the chip collection case 9 through the chip inlet port 71a. Then, through the air inlets 81a and the air outlet 8b, the air passes through the air filter 8 while moving upward, and reaches the centrifugal impeller 5 through the connection hole 70a. The chips M1 are sucked through the chip suction port 4a together with the air in this airflow and introduced into the suction unit 2 through the chip inlet port 71a. When the chips M1 are to pass through the air filter 8, the chips M1 are blocked by the air filter 8 and remain in the chip collection case 9. An operator can thus easily discard the chips M1 remaining in the chip collection case 9 after detaching the chip collection case 9 from the cover 7. In this manner, the chip collection system 1 according to the embodiment of the present invention allows the chips M1 to be collected and discarded efficiently.

In the embodiment of the present invention, as described above, the centrifugal impeller 5 that generates a suction force to collect the chips M1 is rotated by a driving force of the electric motor 6. This structure eliminates, in collecting the chips M1, activation of a compressor typically installed at a factory, unlike in Patent literature 1. This greatly reduces noise generated when the chip collection system 1 is in use without reducing the chip collection performance, thus improving the work environment.

The cover 7 covers the centrifugal impeller 5 and the electric motor 6. Thus, for example, when cooling water for cooling the electrode tips T1 leaks from, for example, the welding gun G and falls from above the suction unit 2, this structure prevents the cooling water from directly accumulating on the electric motor 6 and the centrifugal impeller 5.

The centrifugal impeller 5 is located below the electric motor 6. Thus, the electric motor 6 is less likely to be reached by, for example, the cooling water from below. The chip collection system 1 is thus highly waterproof.

The air filter 8 has the inner space filled with the porous member 83. The porous member 83 in the air filter 8 thus absorbs sound generated when air passes through the air filter 8. This further reduces noise generated when the chip collection system 1 is in use.

The fitting wall 73 of the cover 7 and the fitting hole 13a in the attachment bracket 13 to which the fitting wall 73 is fitted each have a regular dodecagonal shape, and the shapes of the fitting wall 73 and the fitting hole 13a correspond to each other. The fitting wall 73 can thus be fitted into the fitting hole 13a with the cover 7 rotated about the centerline C3 of the cover 7 by a predetermined angle relative to the attachment bracket 13. The position of the chip inlet port 71a with respect to the attachment body B1 can thus be changed based on the surroundings of the suction unit 2.

The cover 7 has, in the portion of the cover 7 corresponding to the centrifugal impeller 5, many outlets 7c arranged along a circumference of the cover 7 in the circumferential direction of the cover 7. Thus, areas through which the discharged air expelled radially outward from the centrifugal impeller 5 passes through the cover 7 are increased, and are arranged in a distributed manner in the circumferential direction of the cover 7. This structure reduces the momentum of the discharged air passing through the cover 7, causing sound produced when the discharged air passes through the cover 7 to be less noisy. This further reduces noise generated when the chip collection system 1 is in use.

The cover 7 has the multiple recessed grooves 7e and the multiple ridges 7f. The cover 7 is thus lighter by the weight of the volume corresponding to the spaces defining the recessed grooves 7e, and has a greater section modulus at the area for each ridge 7f and is thus more rigid. The chip collection system 1 is thus highly rigid and light.

The first split portion 7A and the second split portion 7B can each be formed from a resin material as a single member using a mold with its opening direction set to the direction in which the first split portion 7A and the second split portion 7B are arranged. This avoids undercuts and allows the first split portion 7A and the second split portion 7B with a complex profile having the multiple recessed grooves 7e, the multiple ridges 7f, and the multiple outlets 7c to be molded with a single mold. Fewer molds are thus used in molding, reducing the cost for manufacturing the suction unit 2.

The chip collection case 9 is a single member formed from a transparent resin material. This allows the operator to visually check the inside of the chip collection case 9 from outside. The operator can thus check the collected amount of the chips M1 to discard them. This increases the work efficiency.

The chip collection case 9 has, on its outer circumferential surface, the multiple annular grooves 9b arranged along the cylinder centerline C4. The chip collection case 9 thus has a greater section modulus at a cross section taken along the cylinder centerline C4 and is more rigid with a force in a direction toward the cylinder centerline C4 of the chip collection case 9. Thus, when a large suction force is generated in a direction toward the air filter 8 aligned with the cylinder centerline C4 of the chip collection case 9 during the operation of the chip collection system 1, the chip collection case 9 is prevented from deforming and reducing an area to collect the chips M1.

Although the centrifugal impeller 5 is used to generate a suction force in the above embodiment of the present invention, another type of impeller such as an axial flow impeller or a mixed flow impeller may be used.

Although the fitting hole 13a in the attachment bracket 13 and the fitting wall 73 of the cover 7, which are fitted to each other, have a regular dodecagonal shape in the above embodiment of the present invention, the fitting hole 13a and the fitting wall 73 may have another regular polygonal shape, rather than a regular dodecagonal shape.

Although the filter body 81 has the inner space filled with the porous member 83 in the above embodiment of the present invention, the filter body 81 may include the porous member 83 inside the filter body 81. For example, the porous member 83 may be cylindrical and cover the inner surface of the filter body 81.

### INDUSTRIAL APPLICABILITY

One or more embodiments of the present invention may be implemented as a chip collection system that collects chips produced when the distal end of an electrode tip for spot welding is cut with a tip dresser.

### REFERENCE SIGNS LIST

1 chip collection system
2 suction unit
5 centrifugal impeller
6 electric motor
7 cover
7A first split portion
7B second split portion
7a upper wall
7b side wall
7c outlet
7e recessed groove
7f ridge
8 air filter
8b air outlet
9 chip collection case
9a attachment opening portion
9b annular groove
10 tip dresser
13 attachment bracket
13a fitting hole
70 partition
70a connection hole
71a chip inlet port
73 fitting wall
81a air inlet
83 porous member
B1 attachment body
M1 chip
T1 electrode tip

The invention claimed is:

1. A chip collection system, comprising:
a tip dresser configured to cut a distal end of an electrode tip for spot welding; and
a suction unit configured to suck and collect chips produced when the distal end of the electrode tip is cut with the tip dresser, the suction unit including an electric motor being rotatable, an impeller rotatable by the electric motor to generate a suction force, and a chip collection case into which the chips are collectable, the suction unit being configured to collect chips moving with air sucked in response to rotation of the impeller into the chip collection case.

2. The chip collection system according to claim 1, further comprising:
a cover including an upper wall being disk-shaped and having a centerline extending vertically and a side wall being cylindrical and extending downward from an outer circumferential edge of the upper wall, the cover being open downward, the cover covering the electric motor and the impeller.

3. The chip collection system according to claim 2, wherein
the impeller is a centrifugal impeller with a rotation center extending in a vertical direction and including a suction port facing downward, and
the electric motor is located above the impeller.

4. The chip collection system according to claim 3, wherein
the cover has a chip inlet port through which air including the chips is introduced into an inner space of the cover from outside,
the cover contains, in the inner space, a partition dividing the inner space into an upper area accommodating the electric motor and the impeller and a lower area corresponding to the chip inlet port, and the partition has a connection hole corresponding to the suction port at a center of the partition,
an air filter is located below the partition, the air filter is a vertically elongated bottomed cylinder having an air outlet connecting with the connection hole, and the air filter has, in an outer circumferential surface of the air filter, a plurality of air inlets through which air flows into an inner space of the air filter from outside, and
the chip collection case is a bottomed cylinder having an attachment opening portion being open upward and attachable to the cover to close a lower end opening of the cover.

5. The chip collection system according to claim 4, wherein
the air filter contains a porous member in the inner space.

6. The chip collection system according to claim 4, further comprising:
an attachment bracket with which the suction unit is attachable to an attachment body,
wherein the cover includes a fitting wall having an outer circumferential surface having a regular polygonal shape about a centerline of the cover when viewed in a direction along the centerline, and
the attachment bracket has a fitting hole to receive the fitting wall, and the fitting hole has a same regular polygonal shape as the fitting wall.

7. The chip collection system according to claim 3, wherein
the cover has, in a portion of an outer circumferential surface of the cover corresponding to the centrifugal impeller, a plurality of outlets through which air expelled radially outward from the centrifugal impeller is discharged out of the cover, and the plurality of outlets are arranged along a circumference of the cover.

8. The chip collection system according to claim 7, wherein
the cover has, in an area of the outer circumferential surface of the cover excluding the plurality of outlets, a plurality of recessed grooves arranged adjacent to one another and extending in a same direction and a plurality of ridges arranged adjacent to one another and extending in a same direction, and each of the plurality of ridges is located between adjacent recessed grooves of the plurality of recessed grooves.

9. The chip collection system according to claim 8, wherein
the cover includes a pair of split portions comprising a resin, the pair of split portions are portions of the cover halved at the centerline and having a same shape, and the cover is an assembly of the pair of split portions including opening end edges abutting against each other,
the plurality of recessed grooves are recessed in a direction in which the pair of split portions are arranged,
the plurality of ridges protrude in the direction in which the pair of split portions are arranged, and
the plurality of outlets extend through the cover in the direction in which the pair of split portions are arranged.

10. The chip collection system according to claim 1, wherein
the chip collection case is a single member comprising a transparent resin material.

11. The chip collection system according to claim 4, wherein
the chip collection case has, on an outer circumferential surface of the chip collection case, a plurality of annular grooves arranged in a direction parallel to a cylinder centerline, and each of the plurality of annular grooves is recessed in an arc in a cross section taken along the cylinder centerline and extends along a circumference of the chip collection case about the cylinder centerline.
